(19) United States
(12) Patent Application Publication
(10) Pub. No.: US 2016/0063187 A1
(43) Pub. Date: Mar. 3, 2016

(54) AUTOMATED SYSTEM FOR HANDLING FILES CONTAINING PROTECTED HEALTH INFORMATION

(71) Applicant: ATIGEO CORPORATION, Bellevue, WA (US)

(72) Inventors: Vishnu Vettrival, Bellevue, WA (US); Penny Yee, Bellevue, WA (US); Michael Sandoval, Bellevue, WA (US); David Talby, Bellevue, WA (US)

(73) Assignee: ATIGEO CORPORATION, Bellevue, WA (US)

(21) Appl. No.: 14/835,068

(22) Filed: Aug. 25, 2015

Related U.S. Application Data
(60) Provisional application No. 62/044,008, filed on Aug. 29, 2014.

(51) Int. Cl. G06F 19/00; G06F 21/80; G06F 17/30; G06F 21/62

(52) U.S. Cl. CPC G06F 19/322; G06F 21/6245; G06F 21/80; G06F 17/3012; G06F 17/30194

(57) ABSTRACT

The current document is directed to methods and automated systems for handling files and other data during a data ingestion process that may contain PHI within the file content, filenames, file-associated metadata, and other such data-associated information. The methods and automated systems protect sensitive health information using encryption methods to prevent the protected health information from being exposed. In certain implementations, the currently disclosed automated system includes a client-network system, one or more client servers, an encrypted data-storage device including a source folder for temporarily storing original files downloaded from the client network system and a second folder for storing PHI-free files created from the original files, and processes that create the PHI-free files from the original files, remove the original files from the source folder, and securely copy the PHI-free files to a secure file-transfer protocol server to be processed for later use.

### CROSS-REFERENCE TO RELATED APPLICATION

This application claims the benefit of Provisional Application No. 62/044,008, filed Aug. 29, 2014.

### TECHNICAL FIELD

The current document is directed to computational data-processing systems and, in particular, to automated data-processing systems that securely import computer files that may contain sensitive health information from remote client systems.

### BACKGROUND

Over the past 20 years, the healthcare industry has employed modern economical computer systems with large data-storage capacities and large computational bandwidths to increasingly automate medical record keeping and medical-data processing. It is expected that patient records and information will soon be entirely maintained in electronic medical records. Electronic medical records have many advantages over paper-document-based records and other non-electronic data-storage media, including cost efficiency, standardization, rapid and straightforward transfer of electronic medical records among healthcare providers, healthcare-providing organizations and insurance companies, and efficient processing and analysis of electronic medical records using powerful application programs running on large distributed computer systems, including cloud-computing systems.

The Health Insurance Portability and Accountability Act of 1996 (“HIPAA”) was enacted by the United States Congress in 1996. The HIPAA privacy rule regulates the use and disclosure of Protected Health Information (“PHI”) by healthcare clearinghouses, employer-sponsored health plans, health insurers, medical service providers, and other covered entities. By regulation, the Department of Health and Human Services extended the HIPAA privacy rule to independent contractors of covered entities. PHI is any information held by a covered entity which concerns health status, provision of health care, or payment for health care that can be linked to an individual. This is interpreted rather broadly and includes any part of an individual's medical record or payment history. Designers and developers of computational systems that process electronic medical records therefore continue to seek methods for securing PHI within these computer systems.

### SUMMARY

The current document is directed to methods and automated systems for handling files and other data during a data ingestion process that may contain PHI within the file content, filenames, file-associated metadata, and other such data-associated information. The methods and automated systems protect sensitive health information using encryption methods to prevent the protected health information from being exposed. In certain implementations, the currently disclosed automated system includes a client-network system, one or more client servers, an encrypted data-storage device including a source folder for temporarily storing original files downloaded from the client network system and a second folder for storing PHI-free files created from the original files, and processes that create the PHI-free files from the original files, remove the original files from the source folder, and securely copy the PHI-free files to a secure file-transfer protocol server to be processed for later use.

### BRIEF DESCRIPTION OF THE DRAWINGS

FIG. 1 provides a general architectural diagram for various types of computers, including healthcare-organization computers and medical-data-processing computers and servers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-B illustrate two types of virtual machine and virtual-machine execution environments.

FIG. 6 illustrates virtual data centers provided as an abstraction of underlying physical-data-center hardware components.

FIGS. 7-8 illustrate problems associated with current medical-data-processing systems that fail to recognize that filenames and other file metadata associated with patient files and other medical-information-containing files may contain PHI.

FIGS. 9A-C illustrate one implementation of an automated medical-data-processing system that securely ingests patient files and other medical-data-containing files, securely protecting PHI contained both in the file contents as well as in the file metadata of the ingested files.

FIG. 10 illustrates the components of one implementation of the medical-data-containing-file ingestion subsystem of a medical-data-processing system to which the current document is directed.

FIGS. 11A-B illustrate two asynchronous processes that together comprise the client-service process.

FIG. 12 illustrates the cleaner process that runs within the virtual client server.

FIG. 13 provides a control-flow diagram for the scheduler process.

FIG. 14 provides a control-flow diagram for the listener ingestion service.

### DETAILED DESCRIPTION

Electronic medical records generally contain information about the health status and history of a patient, provider and payment information related to the patient's health care, and other sensitive information that needs to be restricted only to personnel with permission to access such sensitive health information. Protecting the content of electronic medical records is accomplished through the employment of industry-standard encryption technologies, but handling of filenames and related metadata , that may include PHI, such as the size of a file, creation date, last modified date, file owner, access permissions, and other file attributes, introduces another layer of electronically-encoded information that needs to be secured from unauthorized access. Current practice suggests omitting any PHI from the names of files, but PHI can still be found in some filenames and other metadata.

As an example, consider a scenario in which a development team within a medical-information-processing organization is working on a product involving iteration over patient files supplied by a different healthcare organization. All of the supplied files, which contain PHI, are securely transmitted from the healthcare organization to the medical-information-processing organization and stored on a secure drive within a medical-information-processing-organization computer system. The filenames of the patient files contain patient names and/or other patient information, and thus constitute PHI. During automated, routine monitoring and auditing, an information-technology (“IT”) organization within the company may capture the filenames of the stored files and commit them to system audit logs. In addition, monitoring-and-reporting systems monitor the organization's computer systems, including file systems within computers, and send alerts to notify IT personnel and other individuals of file-related problems and anomalies, as a result of which PHI contained in filenames and other file-related metadata may be transmitted through unsecure communications systems to insecure computer systems, exposing PHI to unauthorized personnel. Issuance of such alerts may therefore expose PHI contained in patient-file filenames to acquisition by unauthorized parties and spread PHI to a potentially large number of communication devices and systems. In addition, the IT organization may contract another company for after-hours support and outsourcing of specific tasks. By not properly sanitizing data and by not ensuring the data transmitted to external destinations is devoid of PHI, patient information may be passed to a company that has not entered into a Business Association Agreement. Thus, PHI contained in filenames and other file metadata associated with patient files may be readily leaked from the medical-information-processing organization, despite careful application of encryption and other technologies to avoid exposure of PHI contained within the contents of the patient files.

The current document is directed to methods and automated systems that securely ingest computer files and other data from client computer systems that may contain PHI within the file content, filenames, file-associated metadata, and other such data-associated information. The following discussion includes: (1) a first subsection that describes computer systems and cloud-computing facilities, including those used for generating and processing electronic medical records and other medical-information-containing files; and (2) a second subsection that provides a detailed discussion of the methods and automated systems to which the current document is directed. The discussion, below, details secure ingestion of computer files, but analogous methods can be employed to safely and securely ingest other types of encapsulated data that may contain PHI in attributes, descriptors, and container information associated and ingested along with the data.

### Computers and Cloud-Computing

There is a tendency among those unfamiliar with modern technology and science to misinterpret the terms “abstract” and “abstraction,” when used to describe certain aspects of modern computing. For example, one frequently encounters assertions that, because a computational system is described in terms of abstractions, functional layers, and interfaces, the computational system is somehow different from a physical machine or device. Such allegations are unfounded. One only needs to disconnect a computer system or group of computer systems from their respective power supplies to appreciate the physical, machine nature of complex computer technologies. One also frequently encounters statements that characterize a computational technology as being “only software,” and thus not a machine or device. Software is essentially a sequence of encoded symbols, such as a printout of a computer program or digitally encoded computer instructions sequentially stored in a file on an optical disk or within an electromechanical mass-storage device. Software alone can do nothing. It is only when encoded computer instructions are loaded into an electronic memory within a computer system and executed on a physical processor that so-called “software implemented” functionality is provided. The digitally encoded computer instructions are an essential and physical control component of processor-controlled machines and devices, no less essential and physical than a cam-shaft control system in an internal-combustion engine. Multi-cloud aggregations, cloud-computing services, virtual-machine containers and virtual machines, communications interfaces, and many of the other topics discussed below are tangible, physical components of physical, electro-optical-mechanical computer systems.

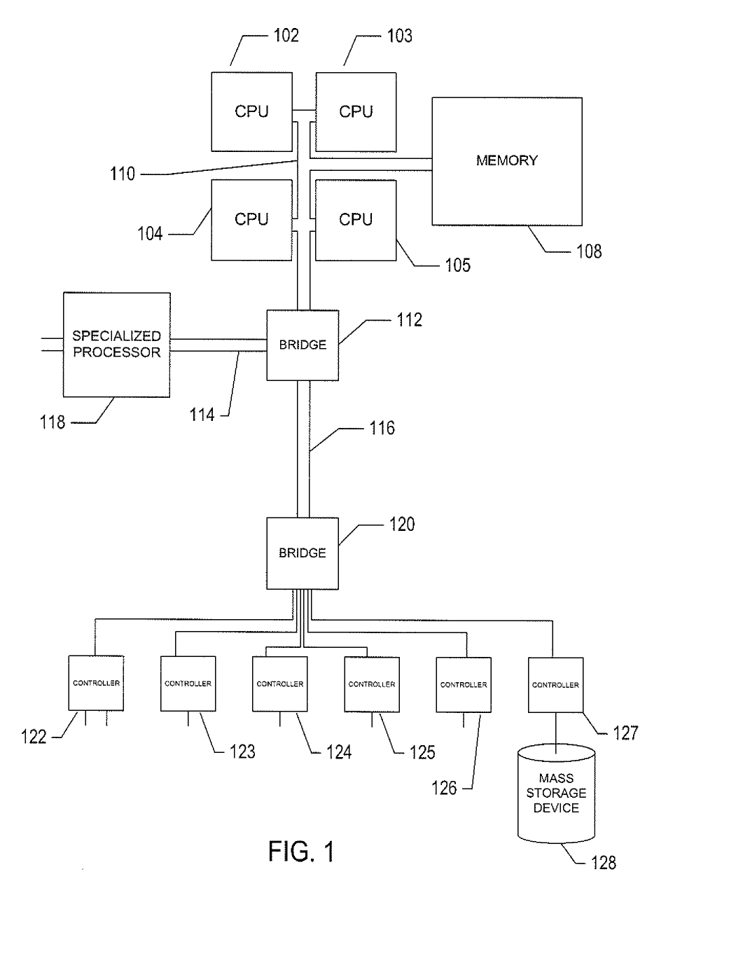

FIG. 1 provides a general architectural diagram for various types of computers, including healthcare-organization computers and medical-data-processing computers and servers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a few bytes or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

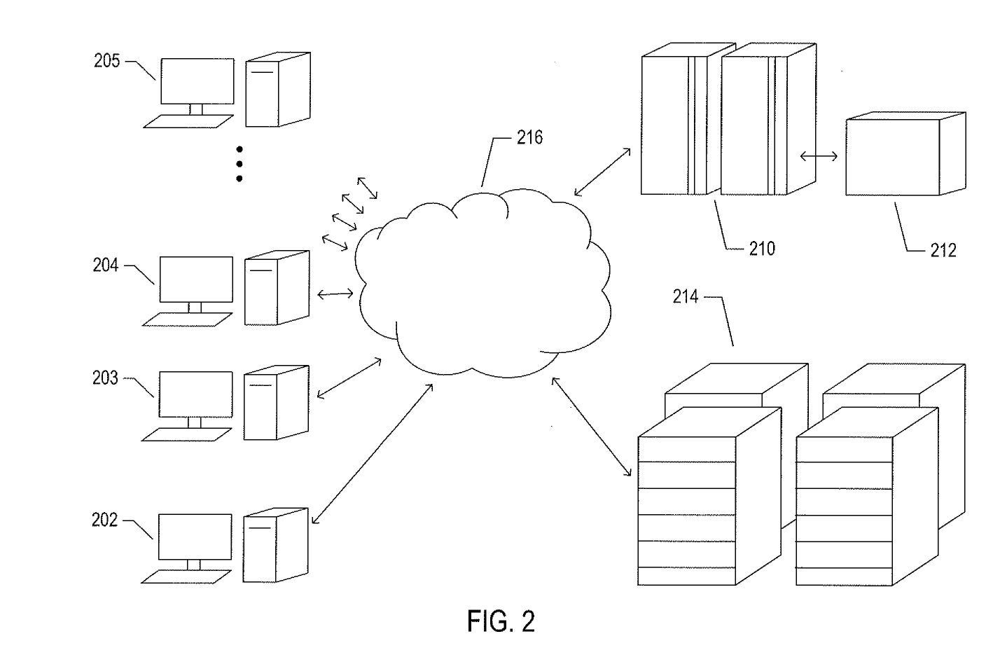

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modem computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computing systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

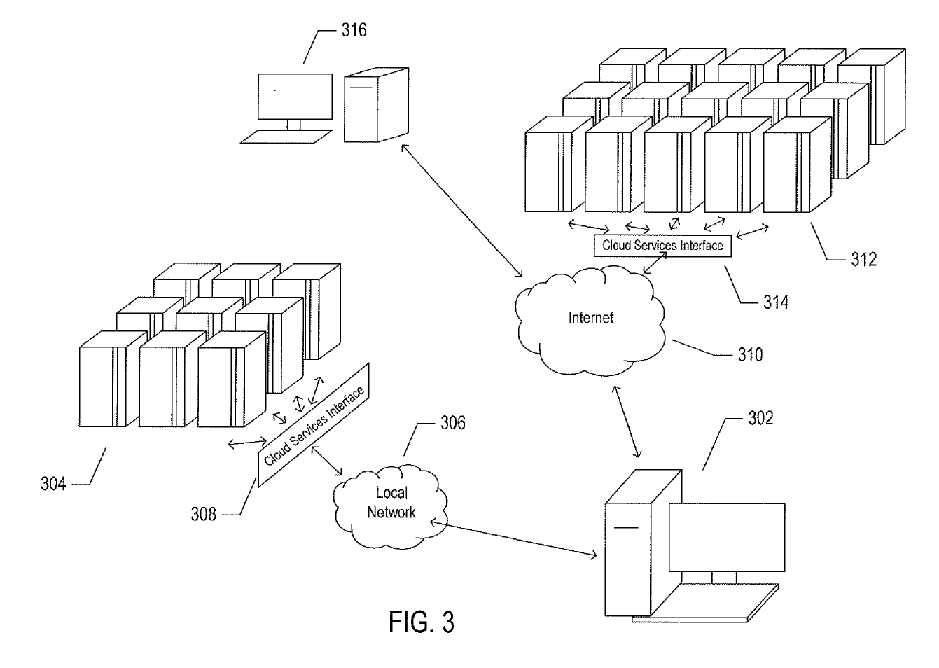

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the resources to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

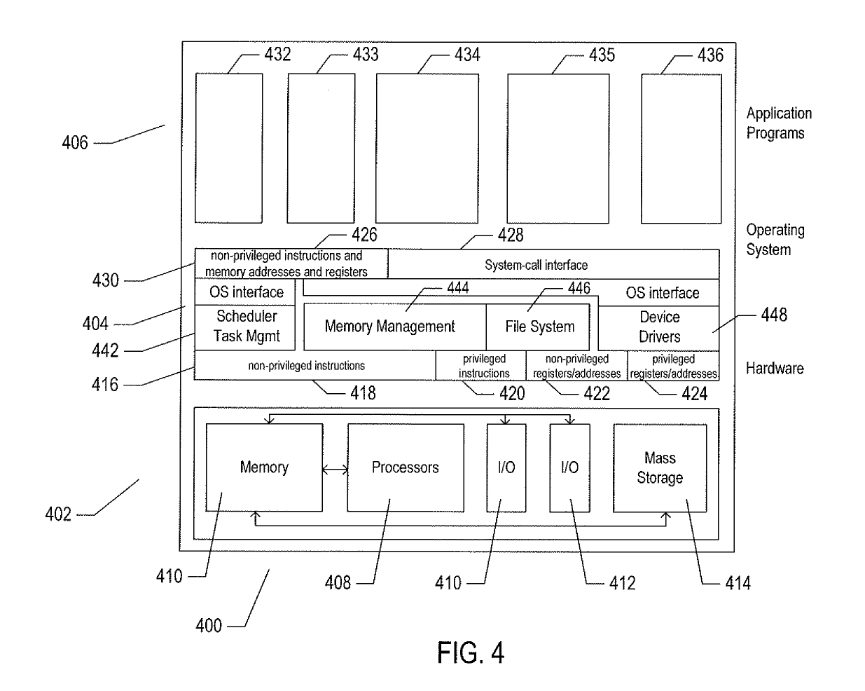

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 436 facilitates abstraction of mass-storage-device and memory resources as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enounously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

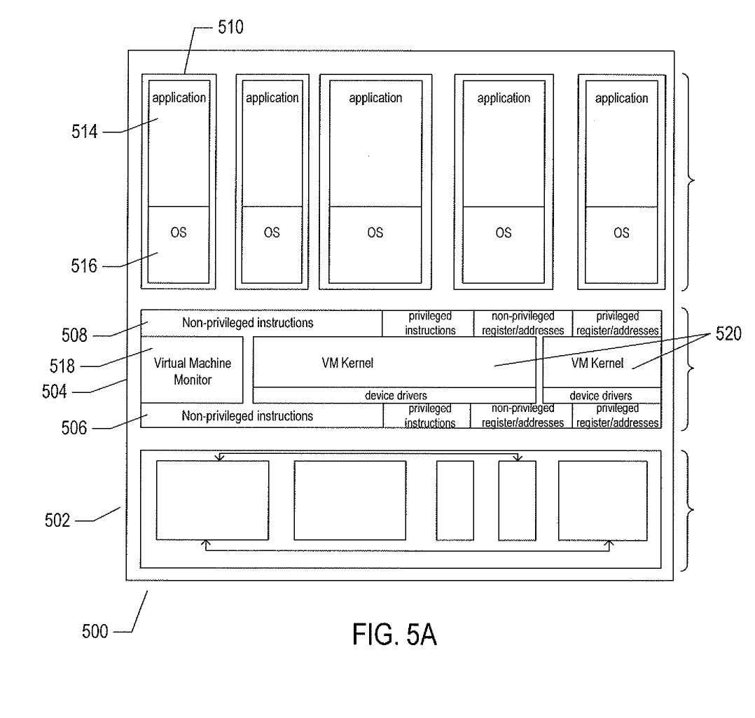

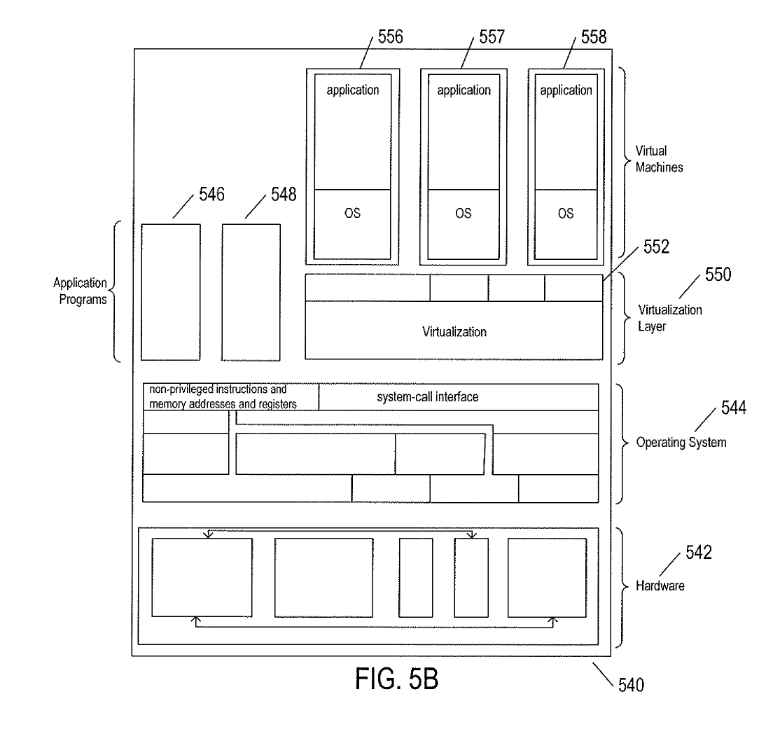

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-B illustrate two types of virtual machine and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

In FIGS. 5A-B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

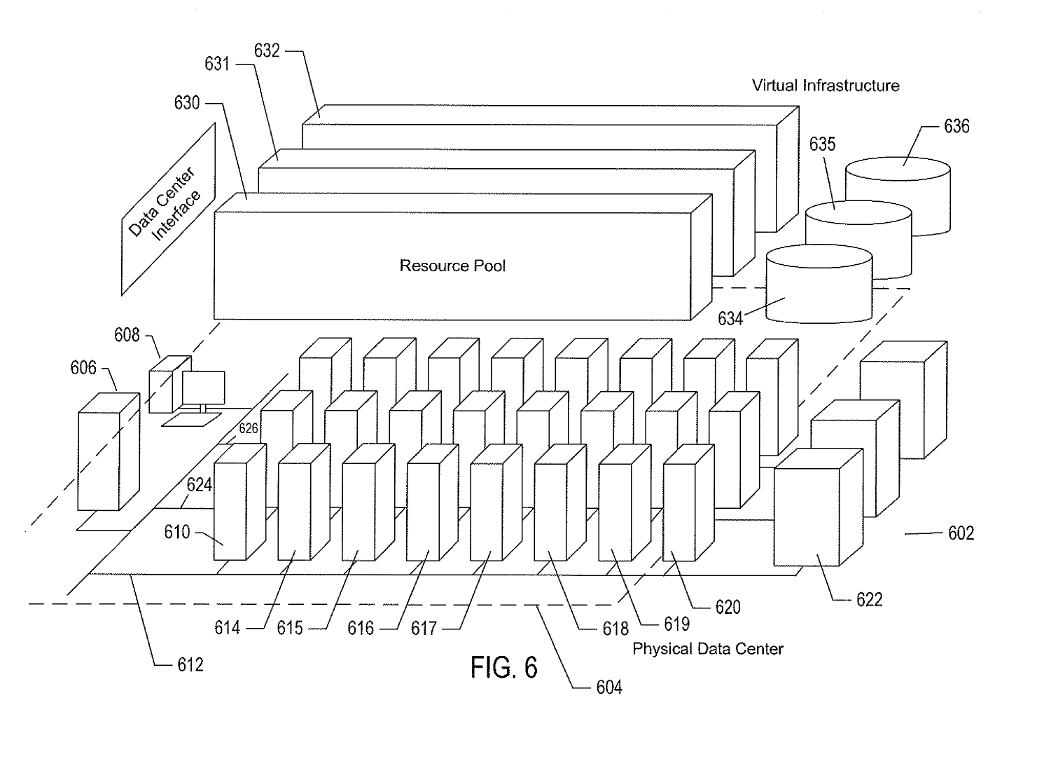

The advent of virtual machines and virtual environments has alleviated many of the difficulties and challenges associated with traditional general-purpose computing. Machine and operating-system dependencies can be significantly reduced or entirely eliminated by packaging applications and operating systems together as virtual machines and virtual appliances that execute within virtual environments provided by virtualization layers running on many different types of computer hardware. A next level of abstraction, referred to as virtual data centers which are one example of a broader virtual-infrastructure category, provide a data-center interface to virtual data centers computationally constructed within physical data centers. FIG. 6 illustrates virtual data centers provided as an abstraction of underlying physical-data-center hardware components. In FIG. 6, a physical data center 602 is shown below a virtual-interface plane 604. The physical data center consists of a virtual-infrastructure management server (“VI management server”) 606 and any of various different computers, such as PCs 608, on which a virtual-data-center management interface may be displayed to system administrators and other users. The physical data center additionally includes generally large numbers of server computers, such as server computer 610, that are coupled together by local area networks, such as local area network 612 that directly interconnects server computer 610 and 614-620 and a mass-storage array 622. The physical data center shown in FIG. 6 includes three local area networks 612, 624, and 626 that each directly interconnects a bank of eight servers and a mass-storage array. The individual server computers, such as server computer 610, each includes a virtualization layer and runs multiple virtual machines. Different physical data centers may include many different types of computers, networks, data-storage systems and devices connected according to many different types of connection topologies. The virtual-data-center abstraction layer 604, a logical abstraction layer shown by a plane in FIG. 6, abstracts the physical data center to a virtual data center comprising one or more resource pools, such as resource pools 630-632, one or more virtual data stores, such as virtual data stores 634-636, and one or more virtual networks. In certain implementations, the resource pools abstract banks of physical servers directly interconnected by a local area network.

### Methods and Automated Systems That Securely Ingest Computer Files from Client Computer Systems That May Contain PHI Within the File Content, Filenames, and File-Associated Metadata

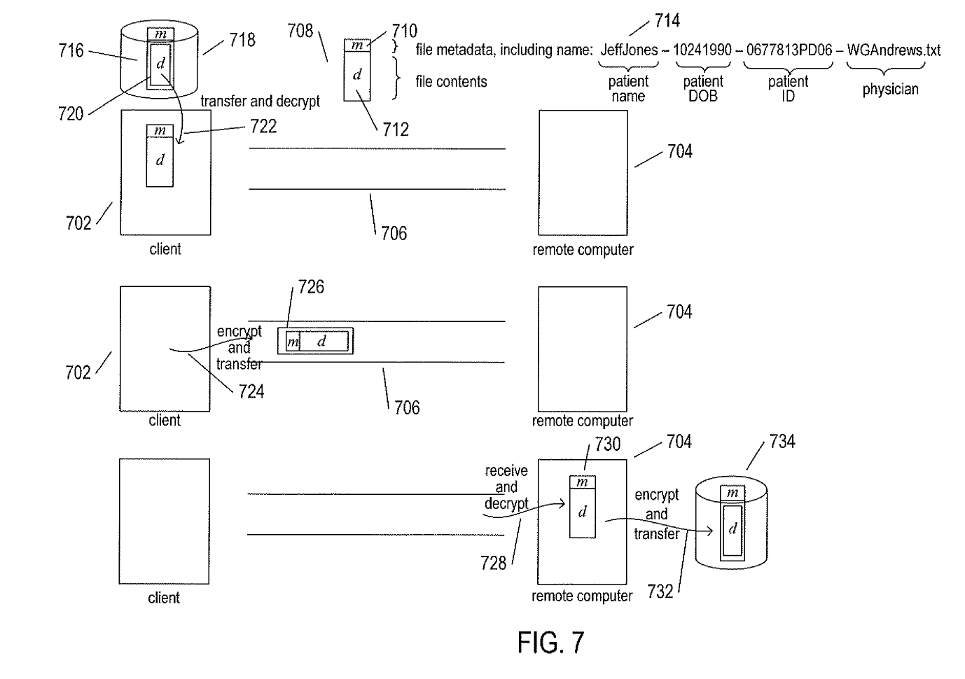

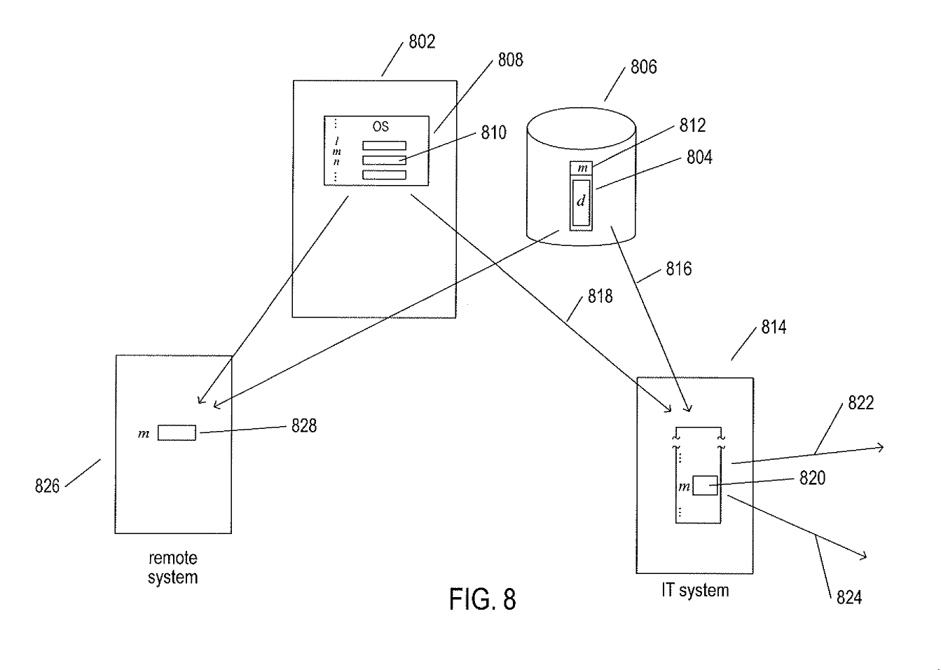

FIGS. 7-8 illustrate problems associated with current medical-data-processing systems that fail to recognize that filenames and other file metadata associated with patient files and other medical-information-containing files may contain PHI. FIG. 7 illustrates a simple scenario in which medical-information-containing files are transferred from a client computer system over a network to a remote computer system of a medical-data-processing organization. In FIG. 7, the client computer 702 and medical-data-processing-organization computer 704 are both represented as rectangles. The communication medium and communication subsystems that allow electronic data to be transferred between the two systems is represented by a horizontal channel 706. In FIG. 7, a medical-information-containing file 708 is represented by a vertically oriented rectangle with two parts 710 and 712. The first part 710 is labeled “m” and the second part 712 is labeled “d.” The first part 710 represents file metadata, including the filename and various additional types of information associated with the file, such as the creation date, size, last-modified date, file-owner identification, access permissions, and other such information, attributes, and properties. The second part 712 is the data, or contents, of the file. As indicated by the text 714 in FIG. 7, the filename portion of the metadata includes the following filename: “JeffJones-10241990-0677893PD06-WGAndrews.txt.” This is an example filename that might be generated by a client and includes, as indicated in FIG. 7, the patient name, patient data of birth, alphanumerical patient ID, and the physician name for a patient whose information is contained in the data, or contents, of the file. It should be noted that the actual structures and formats o0f computer files and the ancillary data associated with computer files are generally operating-system dependent. However, in general, a file, however digitally represented, generally includes both data and metadata.

Initially, the medical-information-containing file 708 is securely stored 716 on a disk drive 718 contained within, or associated with, the client computer 702. In FIG. 7 and in subsequent figures, an additional rectangle 720 is used to indicate encryption. In the case of the initially stored file 716, the data portion, or contents, of the file is encrypted, as indicated by inner rectangle 720. However, the file metadata is not encrypted.

In a series of operations, shown in FIG. 7, the medical-data-containing file 716, securely stored on disk 718, is transferred from the client computer 702 to the remote computer 704 of a medical-data-processing organization. First, as indicated by curved arrow 722, the file 716 is read by the client computer from the disk into memory. The file may be read, in its entirety, in certain cases, or, alternatively, may be read block-by-block or as groups of blocks as the blocks or groups of blocks are separately transmitted through the communications medium 706 to the remote computer. The data contents of the transferred file, in certain cases, may be decrypted within the client computer. Next, the medical-data-containing file, or blocks or groups of blocks of the medical-data-containing file, are encrypted and provided to a communications subsystem for transmission through the communications channel 706 to the remote computer 704, as indicated by curved arrow 724. Thus, when the medical-data-containing file leaves the client computer 702, the entire file is encrypted, as indicated by outer rectangle 726 in FIG. 7.

The file is received and decrypted, as indicated by arrow 728, on the remote computer system 704. The file is shown 730 within the remote computer system in the bottom right-hand portion of FIG. 7. The file contents are then subsequently encrypted when transferred, as indicated by arrow 732, to a mass-storage device 734 within or associated with the remote computer 704. Thus, it would appear, from the operations shown in FIG. 7, that the file contents and file metadata have been both securely protected during the file-transfer operation shown in FIG. 7. The file contents are present in clear text, or unencrypted form, only within the memories of the client computer 702 and remote computer 704. Both during transmission and when stored, the file contents are encrypted. It would appear that the only potential exposure of PHI within or associated with the file occurs only within the client and remote computers. This exposure is clearly necessary for the medical information contained in the file to be processed. It is assumed that when the medical information is present in memory in clear text, or unencrypted form, only trusted applications have access to the file and its contents.

In fact, as discussed above, the data-transfer operation and subsequent storing of the medical-information-containing file in the mass-storage device of the remote computer system is not secure with respect to PHI contained in the file metadata. FIG. 8 illustrates the lack of security of the PHI contained within the file metadata of the file transferred from a client computer system to a medical-data-processing computer system, as shown in FIG. 7. In FIG. 8, the remote computer system 802 is again illustrated as a rectangle. Although the medical-information-containing file 804 is stored within a mass-storage device 806, the remote computer system includes operating-system file directories and other information that refers to, and contains information about, the file 808. As shown in FIG. 8, this information includes all or a portion of the file metadata 810. Note also that the file metadata 812 of the stored file is not encrypted. As a result, an IT system 814 may access the file metadata, as indicated by arrows 816 and 818, from the medical-data-processing computer 802 or, in certain cases, directly from the mass-storage device 806. The metadata, or a portion of the metadata 820 may end up being copied into the memory of the IT system. The IT system may not consider the file metadata to be confidential data and may therefore incorporate this metadata into audit reports that are logged to mass storage and other computer systems, as represented by arrow 822, or may be transmitted in alert messages or other communications to additional remote computer systems, as indicated by arrow 824. In addition, other remote computer systems 826 that can access operating-system data on the medical-data-processing computer system 802 or that can access the mass-storage device 806 may also end up acquiring the file metadata 828. The problem is that the metadata contained within, or associated with, a medical-data-containing file, is generally not considered to be PHI-containing and confidential in many current medical-data-processing systems. Clearly, the data, or contents, of the file are encrypted when the file is stored in the mass-storage device 806. Neither the IT system 814 nor other remote computer systems 826 are generally able to access the file contents or data, since neither the IT system nor the remote system contains the decryption keys and other information needed to decrypt the encrypted file contents. But, because file metadata has not traditionally been viewed as a potential source of PHI, the file metadata is generally not encrypted and is not protected by file systems, operating systems, and other components of computer systems. However, as indicated by the filename shown in FIG. 7, file metadata may, in fact, contain a great deal of PHI, knowledge of which may allow unauthorized accessors to glean confidential information about medical patients.

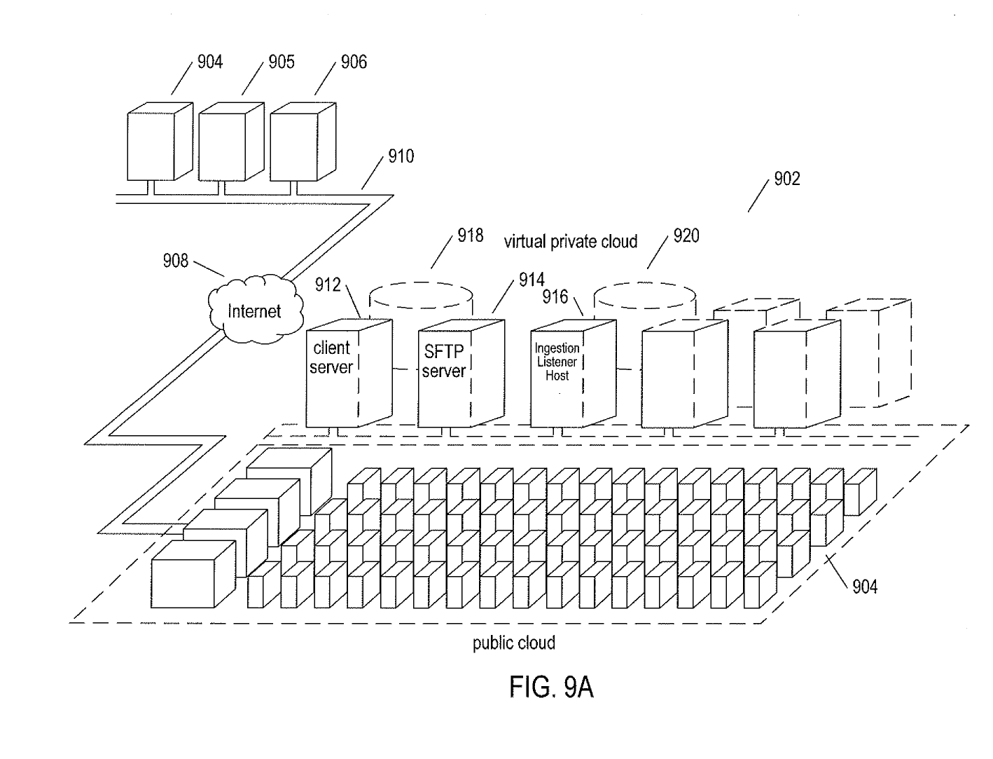

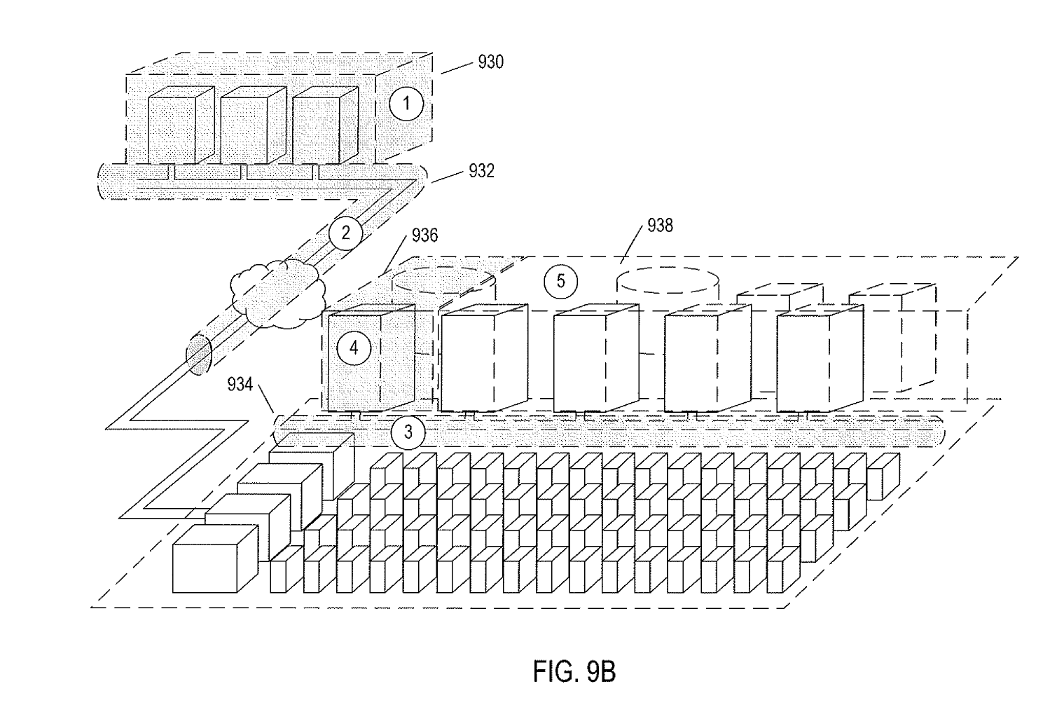

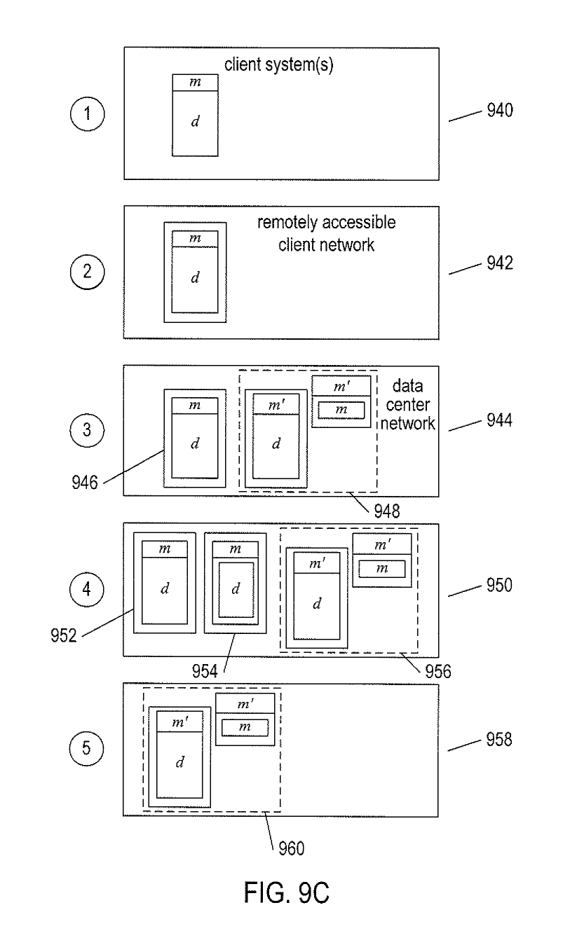

FIGS. 9A-C illustrate one implementation of an automated medical-data-processing system that securely ingests patient files and other medical-data-containing files, securely protecting PHI contained both in the file contents as well as in the file metadata of the ingested files. The automated medical-data-processing system is implemented in a virtual private cloud 902 allocated for the medical-data-processing organization within a public cloud-computing facility 904, as discussed above in the first subsection of the detailed description. The medical-data-processing system accesses medical data stored within remote computers 904-906 via the Internet 908 and a client-computer network 910. The medical-data-processing system includes a client-server virtual server 912, a secure-file-transfer-protocol virtual server 914, and a virtual server 916 that implements an ingestion-listener host. In addition, the medical-data-processing system includes several different encrypted mass-storage device 918 and 920.

FIG. 9B illustrates a number of different protection domains within the client computers and medical-data-processing system shown in FIG. 9A. The client computers comprise a first protection domain 930. Note that, in FIG. 9B, the various protection domains are represented by volumes indicated by dashed lines and are each associated with a circled production-domain number. The first protection domain 930 is represented by a volume that contains only the client computers (904-906 in FIG. 9A). This first protection domain is independent of the medical-data-processing system. It is assumed that the client computers are protected by fire walls, various types of secure-information-storage practices, including encryption, by limited access to computational resources enforced by password and/or biometrics protection, and by other types of security technologies. However, this first protection domain is outside of the control and consideration of the medical-data-processing system.

A second protection domain 932 comprises the client network and Internet. Both the client computer systems and the medical-data-processing system collaborate to ensure that patient files and other medical-data-containing files are securely encrypted prior to transmission through the client network and Internet. Often, this protection is provided by a secure-file-transfer protocol.

A third protection domain 934 comprises the internal virtual networks that link virtual servers of the medical-data-processing system. The medical-data-processing system ensures that medical-data-containing files are fully encrypted within this protection domain and, in general, medical-data-containing files received from clients are partitioned into separately encrypted metadata files and content files, as further discussed below. Moreover, the virtual networks allocated to the medical-data-processing system are additionally secured by various types of encryption technologies and other security technologies from access, within the cloud-computing facility 904, by virtual servers within virtual private clouds allocated on behalf of other organizations that use the cloud-computing facility.

A fourth protection domain 936 comprises the virtual client server (912 in FIG. 9A) and a virtual secure mass-storage device (918 in FIG. 9A) associated with the client server. The fourth protection domain is the only protection domain, other than the first protection domain, in which the metadata associated with medical-data-containing files is stored in clear-text form. As discussed further, below, the metadata is stored in clear-text form only temporarily, until ingested medical-data-containing files are processed to secure the metadata. Medical-data-containing files within the fourth protection domain 936 are protected from access by a variety of different security techniques. For example, only three processes involved in downloading client files are provided access rights to medical-data-containing files stored within the fourth protection domain, in one implementation. Moreover, the virtual mass-storage device (918 in FIG. 9A) associated with the virtual client server is fully encrypted. The file system folder in which newly downloaded medical-data-containing files are stored is not accessible to remote processes or local processes other than the three processes allowed access to medical-data-containing files within the virtual client server, and, in particular, is not accessible for various types of IT monitoring and logging. Any attempted access to medical-data-containing files are monitored within the fourth protection domain in order to ensure that only the authorized processes attempt to access medical-data-containing files. Thus, the fourth protection domain is somewhat like a special intake domain within which downloaded medical-data-containing files are processed to render them secure for exchange between virtual servers and other components of the medical-data-processing system.

The final protection domain 938 includes all of the other virtual servers and virtual mass-storage devices within the medical-data-processing system. Within this protection domain, medical-data-containing files have been partitioned into a metafile and a data file, both with non-PHI-containing filenames, and both always encrypted during transfers between virtual machines and mass-storage devices and when stored on virtual mass-storage devices. Thus, in the fifth protection domain, the metadata associated with medical-data-containing files is fully protected from unintended or inadvertent access by unauthorized parties.

FIG. 9C illustrates how medical-data-containing files are protected in each of the five protection domains discussed above with reference to FIG. 913. In the first protection domain 940, no assumption is made, by the medical-data-processing system, with respect to protection and security of medical-data-containing files. Presumably, the client systems employ encryption and other technologies to protect medical files, but this protection domain is outside of the control or interest of the medical-data-processing system. In the second protection domain 942, medical-data-containing files are fully encrypted, including both the metadata and the contents of the file. In the third protection domain 944, either the medical-data-containing files are fully encrypted 946, as in the case of the second protection domain, or, alternatively, are partitioned into a pair of files 948, including a meta file and data file, the contents of both of which are encrypted. In the fourth protection domain 950, medical-data-containing files may be fully encrypted 952, may be encrypted, with the contents doubly encrypted 954, or may be partitioned into two files, including a metafile and data file 956, the contents of which are encrypted. In the fifth protection domain 958, medical-data-containing files are stored and transferred as a pair of meta and data files 960, the contents of which are encrypted. Of course, in both the fourth and fifth protection domains 950 and 958, the metadata and contents of a medical-data-containing file may be decrypted and temporarily present, in memory of a virtual server, in clear-text fowl during data-processing operations. However, the encryption keys and other information about the medical-data-containing files are provided only to authorized processing routines that are guaranteed to observe transfer and storage secure protocols in order to prevent any exposure of PHI contained within the medical-data-containing files or associated metadata. As can be readily observed in FIG. 9C, the currently disclosed medical-data-processing system ensures that both the contents and metadata of a medical-data-containing file are never exposed to, or vulnerable to access by, unauthorized computational entities.

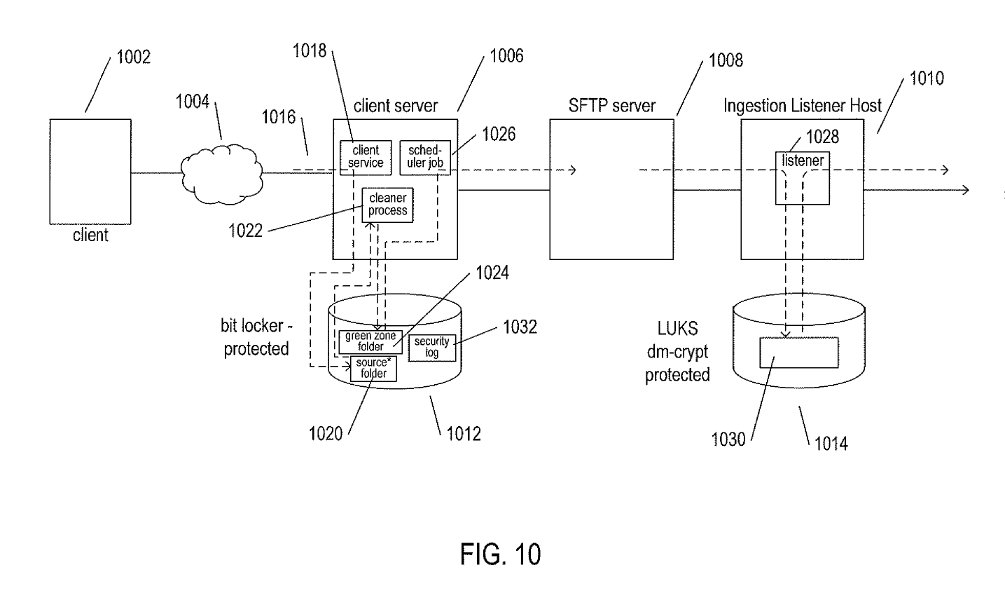

FIG. 10 illustrates the components of one implementation of the medical-data-containing-file ingestion subsystem of a medical-data-processing system to which the current document is directed. In FIG. 10, a remote client computer 1002 is shown connected through the Internet 1004 to a virtual client server 1006 within the medical-data-processing system. The virtual client server is, in turn, connected to a secure-file-transfer-protocol (“SFTP”) server 1008, in turn connected to an ingestion listener host implemented within a virtual server 1010. The virtual client server 1006 contains, or is associated with, a mass-storage device 1012 protected by the Windows® Bitlocker™ Drive encryption solution and the ingestion listener host 1010 contains, or is associated with, a Linux Unified Key Setup (“LUKS”) DM-crypt protected mass-storage device 1014. In FIG. 10, the paths of medical-data-containing files and files derived from the medical-data-containing files through the ingestion subsystem are indicated by dashed arrows, such as dashed arrow 1016. A client-service process 1018 within the virtual client server 1006 continuously identifies medical-data-containing files available for download from the client system 1002 and downloads the files into a source folder 1020 within the mass-storage device 1012. In one implementation, the source folder organizes the files via timestamps. The source folder is not exposed to, or accessible by, processes which audit files and carry out other IT operations and can only be accessed by the client-service process 1018 and a cleaner process 1022 that execute within the virtual client server 1006. Auditing can be enabled for tracking changes made to the access controls associated with the source folder so that access to the source folder can be monitored for security purposes. The cleaner process 1022 extracts medical-data-containing files from the source folder 1020, partitions the files into pairs of meta and data files with non-PHI-containing filenames, and stores the pairs of meta and data files in a green-zone folder 1024 within the mass-storage device 1012. In one implementation, the green-zone folder organizes the files via timestamps. System auditing and logging is generally enabled for the green-zone folder. A scheduler job 1026 periodically removes meta and data file pairs from the green-zone folder 1024 and transfers the files to the SFTP server 1008. A listener process 1028 within the ingestion listener host 1010 monitors the SFTP server for available file pairs and transfer the files to an encrypted volume 1030 within the mass-storage device 1014. In addition, the listener process evaluates the file pairs to determine to which target processing application they should be forwarded, alerts the target the application, and cooperates with the target application to transfer the file pairs to the target application. Note that any logging or audit information associated with the source folder 1020 is stored in a secure, encrypted log 1032 within the mass-storage device 1012.

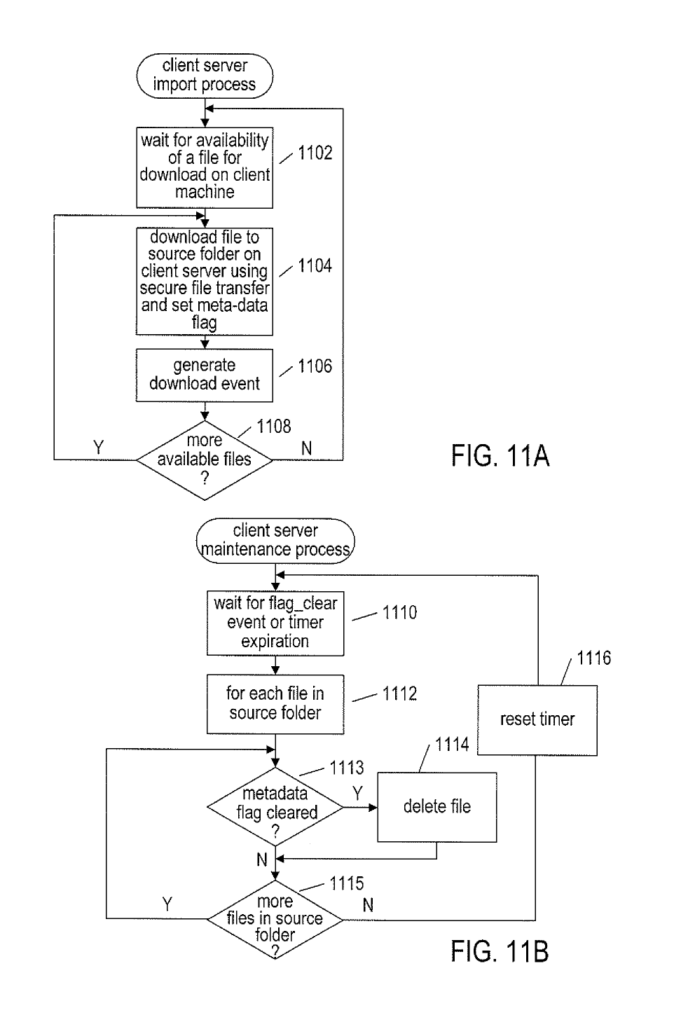

FIGS. 11A-B illustrate two asynchronous processes that together comprise the client-service process (1018 in FIG. 10). In one implementation, the client-service process is a persistent Windows® Service. The client-server import process, shown in FIG. 11A, continuously executes in order to download medical-data-containing files from remote client systems into the medical-data-processing system. In step 1102, the process waits for a next available medical-data-containing file for download from a client computer. There are various different types of techniques by which the client-server import process can determine availability of files for downloading. The process may periodically access known shared resources on the client machines, may receive signals or messages from the client network that indicate the availability of files for download, or may listen for, and receive, medical-data-containing files sent from client computer systems. Once one or more files are available for download from the client network, the client-server import process downloads a next file to the source folder using a secure file transfer protocol and sets a meta-data flag associated with the file, in step 1104. Of course, a flag may be set by setting the value to “1” and cleared by setting the value to “0,” according to one convention, but may also be set by setting the value to “0” and cleared by setting the value to “1,” according to a different convention In step 1106, the client-server import process generates a download event. When more files are available for download, as determined in step 1108, control returns to step 1104. Otherwise, control returns to step 1102.

The client-server maintenance process, a control-flow diagram for which is provided in FIG. 11B, continuously removes medical-data-containing files from the source folder. In step 1110, the client-server maintenance process waits for a flag_clear event or a timer expiration. Once awakened, the client-server maintenance process, in the for-loop of steps 1112-1115, deletes any medical-data-containing files with cleared meta-data flags from the source folder. Then, the client-server maintenance process resets a timer associated with the process, in step 1116, and returns to step 1110 to await for another flag_clear event or timer expiration. In alternative implementations, the scheduler process, discussed below, removes medical-data-containing files from the source folder. In certain implementations, the file removal may be carried out by underlying secure-volume functionality.

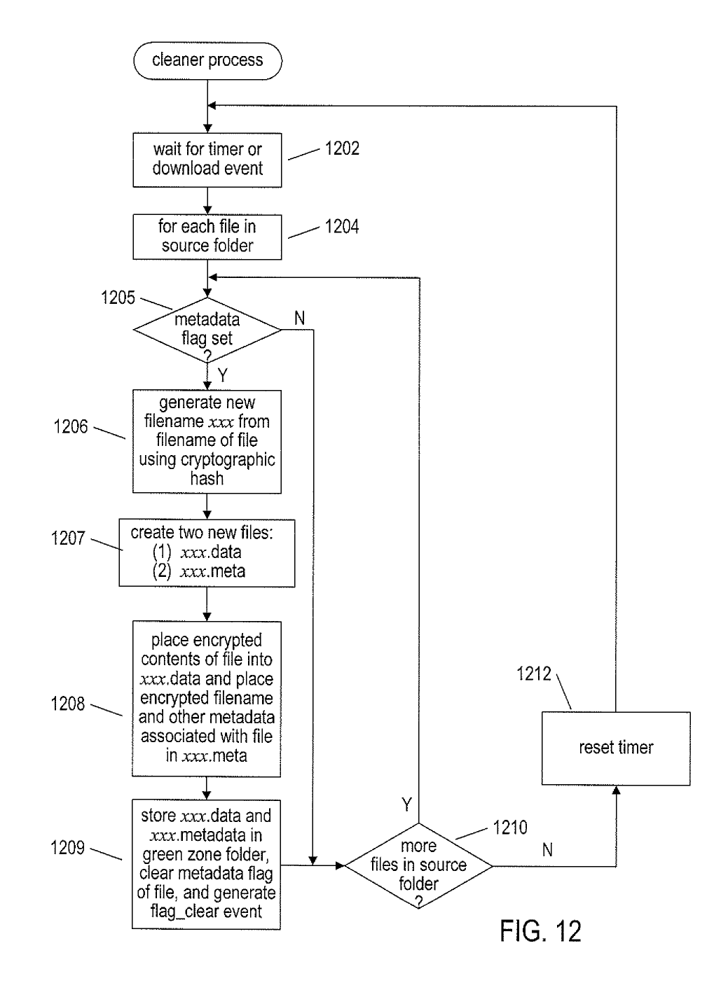

FIG. 12 illustrates the cleaner process (1022 in FIG. 10) that runs within the virtual client server (1006 in FIG. 10). In step 1202, the cleaner process waits for timer expiration or a download event. When awakened, the cleaner process considers each file in the source folder in the for-loop of steps 1204-1210. When the meta-data flag is set, as determined in step 1205, the cleaner process processes the file. First, in step 1206, the cleaner process generates a new filename, represented in FIGS. 12-14 as xxx from the filename of the file using a cryptographic hash or other such unique-name-generation method. The new filename is generated in a way that no PHI is present in the new filename. In step 1207, the cleaner process creates two new files xxx.data and xxx.meta. In step 1208, the cleaner process places the encrypted contents of the file into a new file xxx.data and places the encrypted filename and other metadata associated with the file in the new file xxx.meta. In step 1209, the cleaner process stores the file pair xxx.data and xxx.meta in the green zone folder, clears the metadata flag associated with the file, and generates a flag_clear event. When there are more files in the source folder to process, control returns to step 1205. Otherwise, the cleaner process resets the timer associated with the cleaner process, in step 1212, and returns to step 1202 to wait for more downloaded files to process.

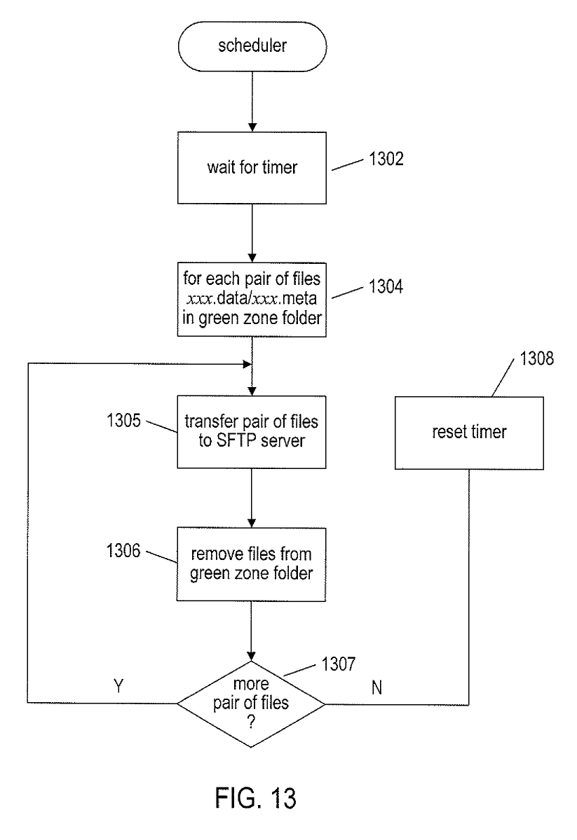

FIG. 13 provides a control-flow diagram for the scheduler process (1026 in FIG. 10). In step 1302, the scheduler waits for expiration of a timer associated with the scheduler process. When awakened, the scheduler, in the for-loop comprising steps 1304-1307, processes each pair of files stored in the green zone folder. In step 1305, the pair of files is transferred to the SFTP server (1008 in FIG. 10). In step 1306, the scheduler removes the pair of files from the green-zone folder, once the scheduler determines that the pair of files has been successfully transferred to the SFTP server. In step 1308, the timer associated with the scheduler is reset prior to a return to step 1302. Note that the pair of files is additionally encrypted by the SFTP protocol.

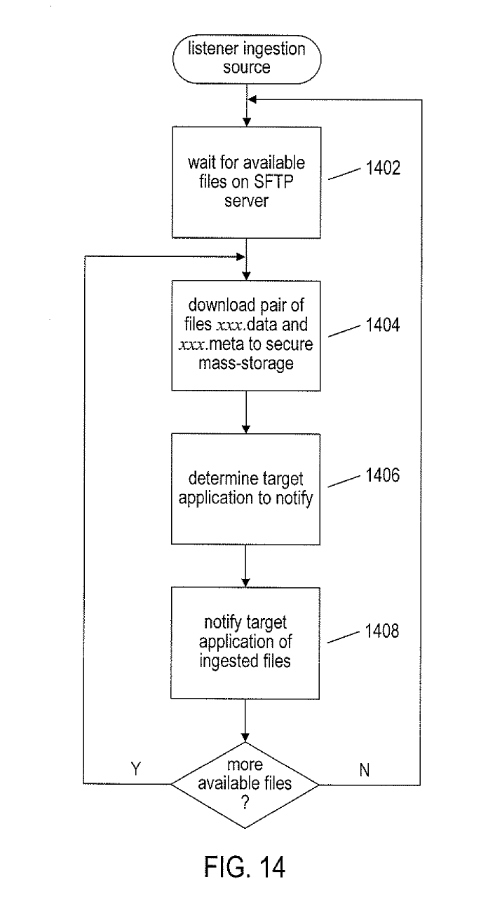

FIG. 14 provides a control-flow diagram for the listener ingestion service (1028 in FIG. 10). In step 1402, the listener ingestion service waits for available files to process on the SFTP server. When awakened, the listener ingestion service downloads a next pair of data and meta files to a secure mass-storage device, in step 1404. In addition, in step 1406, the listener ingestion service analyzes the contents of the meta and data files of the pair to determine which target application within the medical-data-processing system should receive the downloaded files for processing. In step 1408, the listener ingestion service notifies the target application of the presence of the ingested files. In certain cases, the target application may directly access the ingested files from the secure disk. In other implementations, the target application may request that the listener ingestion service forward the files from the secure mass-storage device to the target application.

As mentioned above, Bitlocker™ and LUKS/dm-crypt encryption solutions may be used to protect sensitive data and prevent PHI from being potentially exposed. Bitlocker™ drive encryption is a full-disk encryption solution provided in Windows®. A destination drive to which files may be downloaded can be encrypted by Bitlocker™. In one implementation, the destination drive includes the source folder, the green-zone folder, and application programs, such as the cleaner process and scheduler process. A recovery key for accessing the destination drive is stored to one or more secure shares on another machine physically separated from the destination drive in order to prevent the protected data files and the means to unlocking the protected data files from becoming a potential single point of failure.

The encrypted drive is locked at shutdown and unlocked at startup. The following steps are taken to unlock the encrypted drive at startup. First, a scheduled job runs at startup to access the one or more secure shares and to unlock the encrypted drive. The scheduled job may execute a command line such as:

c:\Windows\system32\manage-bde.exe-unlock-RecoveryKey
“\\ServerStoringKey\KeyShare$\ServerName\DriveD\#######-####-####-BEK” d: where manage-bde.exe is the name of the executable;
\\ServerStoringKey\KeyShare$\ServerName\DriveD\is the location of the share;
#######-####-####-####.BEK is the name of the file that stores the recovery key;
and d is the name of the destination drive.
   Access to the share that contains the recovery key is managed and authorized through Active Directory™, a directory service developed by Microsoft®™ that authenticates and authorizes users and computers in a Windows® domain type network. Second, after the recovery key is located and applied, the encrypted drive is unlocked, providing access to the data files stored in the drive. Application programs that handle files containing PHI run only from the unlocked drive and accompanying log files are only stored in this drive.

Since access to files need to be audited, file-access auditing may lead to capturing filenames containing PHI. Therefore, additional steps need to be taken to ensure that the Windows® Security Event logs created and modified by auditing are encrypted. The following steps are taken, in one implementation, to ensure that logs are created and reside only in an encrypted location. First, using Windows® Encrypted File System (“EFS”), an encrypted folder is created, which is used to store the Windows® Security Event logs created by auditing. A command line may be used to create an encrypted folder, such as:

Cipher.exe/EfolderName
where EfolderName is the name of the newly created encrypted folder;

Cipher.exe is a command-line tool used to manage encrypted data by using the EFS. Second, security log settings are configured to establish that the logs created will be written to the newly created encrypted folder. Third, EFS is configured to ensure that the user name “system” is added to the list of the users that can access the logs. Fourth, after the system is rebooted, the original security logs are removed from the default location, for example, %windir%\system32\winevt\logs. Finally, an additional step is taken to verify that new events are appearing in the encrypted event log that is written to the encrypted folder.

Similar to Bitlocker™ in Windows®, LUKS is a standard for Linux hard disk encryption that affords the ability to encrypt full disks or a disk partition on a Linux system. LUKS/dm-crypt is a Linux encryption module that supports LUKS. LUKS/dm-crypt provides transparent encryption of block devices, which is natively supported in Linux kernel. LUKS/dm-crypt allows for using multiple user passphrases to decrypt a master passphrase, equivalent to the recovery key in Bitlocker™, that is used for full disk or disk partition encryption. Similar to the Bitlocker™ drive encryption solution, an encryption target location, which is generally a storage location used for storing potential PHI-containing data files, is locked at shutdown and unlocked at startup. In one implementation, the encrypted target location is an /opt directory. To unlock and access the encrypted target location, a master passphrase needs to be retrieved first. The master passphrase is retrieved by accessing a Remote Secure Share Drive (“RSSD”) location, retrieving the master passphrase from the RSSD location, and storing the retrieved master passphrase locally in a temporary file system location, such as /media/tmpfs. The master-passphrase-retrieving process is conducted at startup and controlled by an encryption configuration file, named crypttab, that includes a keyscript option containing the RSSD location and credentials needed to access the master passphrase. Access to the local folder that temporarily stores the master passphrase, for example, /media/tmpfs, is limited to the root user and the temporary folder is flushed when the system shuts down. After the master passphrase is retrieved, LUKS/dm-crypt uses the retrieved master passphrase to create an unencrypted device mapper target, for example, secure, which is set up within /dev/mapper/ and exposed as /dev/mapper/secure. Another system configuration file /etc/fstab that maps disks and disk partitions to mount points, is read and /dev/mapper/secure is mounted to /opt.

Although the present disclosure has been described in terms of particular implementations, it is not intended that the disclosure be limited to these implementations. Modifications within the spirit of the disclosure will be apparent to those skilled in the art. For example, any of various design and implementation parameters, including choice of hardware platform, virtualization layers, operating systems, programming languages, modular organization, control structures, data structures, and other such parameter can be altered to produce many different implementations of the automated system for handling PHI-containing files. The foregoing descriptions of specific implementations of the present disclosure are presented for purposes of illustration and description. As one example, data encapsulated in data containers other than files may also be associated with additional, PHI-containing attributes, qualifications, or containers, and may need to be ingested analogously to the above-described ingestion methods that remove PHI from the attributes, qualifications, or containers prior to distributing the data within a data-processing system into which the encapsulated data is ingested.

It is appreciated that the previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

1. A secure-ingestion subsystem within an automated medical-data-processing system that securely receives medical-data-containing files from a client computer system, the secure-ingestion subsystem comprising:
a client server, including one or more processors and one or more memories, that is connected through one or more communications media and communications subsystems to the client computer system; and
one or more processes that run within the client server to
download encrypted medical-data-containing files from the client computer system through the one or more communications media and communications subsystems,
store the medical-data-containing files on an encrypted mass-storage device, and
for each medical-data-containing file stored on the encrypted mass-storage device,
generate a new filename,
create a meta file and a data file with filenames based on the new filename,
write medical-data-containing-file metadata into the meta file,
write medical-data-containing-file content into the data file,
store the meta file and data-file on the encrypted mass-storage device, and
delete the medical-data-containing file from the encrypted mass-storage device.

2. The secure-ingestion subsystem of claim 1 wherein the medical-data-processing system is implemented with virtual servers, mass-storage devices, and networks that together comprise a virtual data center within a cloud-computing facility.

3. The secure-ingestion subsystem of claim I wherein the new filename is generated by applying a cryptographic hashing method to all or a portion of the medical-data-containing-file filename.

4. The secure-ingestion subsystem of claim 1 wherein the new filename does not contain protected health information.

5. The secure ingestion subsystem of claim 1 wherein the medical-data-containing-file metadata includes one or more of a filename that may contain protected health information;
a file-creation date;
an identification of a file creator;
a file size;
a last-modified date;
a file-owner identification; and
access permissions.

6. The secure ingestion subsystem of claim 1 wherein the medical-data-containing-file content includes data that may contain protected health information.

7. The secure ingestion subsystem of claim 1 wherein the encrypted mass-storage device is protected by the Windows Bitlocker Drive encryption solution.

8. The secure ingestion subsystem of claim 1 wherein the client server continuously or intermittently executes:
an import process that downloads the encrypted medical-data-containing files from the client computer system through the one or more communications media and communications subsystems and stores the medical-data-containing files in a source folder on the encrypted mass-storage device; and
a cleaner process that, for each medical-data-containing file stored by the import process in the source folder on the encrypted mass-storage device, generates the new filename, creates the meta file and the data file with filenames based on the new filename, writes the medical-data-containing-file metadata into the meta file, writes the medical-data-containing-file content into the data file, stores the meta file and data-file in a green-zone folder on the encrypted mass-storage device, and deletes the medical-data-containing file from the encrypted mass-storage device.

9. The secure ingestion subsystem of claim 8 wherein the source folder is accessible only by the import process and the cleaner process.

10. The secure ingestion subsystem of claim 8 wherein the client server additionally executes a scheduler process that transfers each meta-file/data-file pair stored in the green-zone folder to a secure-file-transfer server within an automated medical-data-processing system.

11. The secure ingestion subsystem of claim 10 further including a listener ingestion process executed by a listener ingestion host server within the automated medical-data-processing system, the listener ingestion process:
receiving meta-file/data-file pairs from the SFTP server; and
for each received meta-file/data-file pair,
determining to which automated-medical-data-processing-system application to send the received meta-file/data-file pair,
storing the received meta-file/data-file pair on a second encrypted mass-storage device, and
arranging for transfer of the meta-file/data-file pair to the determined automated-medical-data-processing-system application.

12. The secure ingestion subsystem of claim 10 wherein the second encrypted mass-storage device is protected by the LUKS DM-crypt technology.

13. The secure ingestion subsystem of claim 1 wherein the metadata and content of a medical-data-containing file downloaded by the import process are both encrypted from when the medical-data-containing file is transmitted to the one or more communications media and communications subsystems by the client computer system until the meta-file/data-file pair corresponding to the medical-data-containing file is received by an application within the automated medical-data-processing system that processes the meta-file/data-file pair, preventing exposure of any protected health information contained in either the medical-data-containing-file metadata and the medical-data-containing-file content.

14. A method, carried out within an automated medical-data-processing system, that securely ingests medical-data-containing files from a client computer system, the method comprising:
downloading, by an import process executing on a client server that includes one or more processors and one or more memories and that is connected through one or more communications media and communications subsystems to the client computer system, encrypted medical-data-containing files from the client computer system;
storing, by the import process, the medical-data-containing files on an encrypted mass-storage device; and
for each medical-data-containing file stored by the import process on the encrypted mass-storage device,
generating, by a cleaner process, a new filename,
creating, by the cleaner process, a meta file and a data file with filenames based on the new filename,
writing, by the cleaner process, medical-data-containing-file metadata into the meta file,
writing, by the cleaner process, medical-data-containing-file content into the data file,
storing, by the cleaner process, the meta file and data-file on the encrypted mass-storage device, and
deleting, by the cleaner process, the medical-data-containing file from the encrypted mass-storage device.

15. The method of claim 14
wherein the new filename is generated by applying a cryptographic hashing method to all or a portion of the medical-data-containing-file filename; and
wherein the new filename does not contain protected health information.

16. The method of claim 15 wherein the import process stores the medical-data-containing files in a source folder on the encrypted mass-storage device, the source folder accessible only to the import and cleaner processes.

17. The method of claim 15 wherein the cleaner process stores the meta file and data-file as a meta-data/data-file pair in a green-zone folder on the encrypted mass-storage device.

18. The method of claim 17 further including transferring, by a scheduler process running on the client server, each meta-file/data-file pair stored in the green-zone folder to a secure-file-transfer server within an automated medical-data-processing system.

19. The method of claim 10 further including:
receiving, by a listener ingestion process executed by a listener ingestion host server within the automated medical-data-processing system, meta-file/data-file pairs from the SFTP server; and
for each received meta-file/data-file pair,
determining, by the listener ingestion process, to which automated-medical-data-processing-system application to send the received meta-file/data-file pair,
storing, by the listener ingestion process, the received meta-file/data-file pair on a second encrypted mass-storage device, and
arranging for transfer of the meta-file/data-file pair, by the listener ingestion process, to the determined automated-medical-data-processing-system application.

20. Computer instructions, stored on a physical data-storage device, that, when executed by a client server within an automated medical-data-processing system, control the client server to:
download encrypted medical-data-containing files from the client computer system;
store the medical-data-containing files on an encrypted mass-storage device; and
for each medical-data-containing file stored by the import process on the encrypted mass-storage device,
generate a new filename,
create a meta file and a data file with filenames based on the new filename,
write medical-data-containing-file metadata into the meta file,
write medical-data-containing-file content into the data file,
store the meta file and data-file on the encrypted mass-storage device, and
delete the medical-data-containing file from the encrypted mass-storage device.
